(19) United States
(12) Patent Application Publication
(10) Pub. No.: US 2022/0010223 A1
(43) Pub. Date: Jan. 13, 2022

(54) GAS GENERATING PLANT AND GAS GENERATION PROCESS FOR THE PRODUCTION OF HYDROGEN-CONTAINING SYNTHESIS GAS

(71) Applicant: OOO TEK, St. Petersburg (RU)

(72) Inventors: Juriy Shubyankin A., St. Petersburg (RU); Vyacheslav Ivanov A., St. Petersburg (RU)

(73) Assignee: OOO TEK, St. Petersburg (RU)

(21) Appl. No.: 17/305,598

(22) Filed: Jul. 10, 2021

(30) Foreign Application Priority Data
Jul. 10, 2020 (DE) 10 2020 208 690.7

(51) Int. Cl. C10J 3/62; C10B 57/10; C10B 57/00; C10B 21/08; C01B 3/02; B01J 6/00; C10J 3/82

(52) U.S. Cl. CPC C10J 3/62; C10B 57/10; C10B 57/005; C10B 21/08; C10J 2300/1628; B01J 6/008; C10J 3/82; C10J 2300/123; C10J 2300/0909; C01B 3/02

(57) ABSTRACT

A gas generation plant for generating hydrogen-containing synthesis gas includes a gas generation reactor which is oriented in the vertical direction being greater in length vertically than width. A gas inlet is designed for the passage of superheated water vapor into the gas generation reactor. Through an upper outlet, a gas/water vapor mixture can exit the gas generation reactor and be reused in the second heating element after having been superheated. Synthesis gas can exit through a lower gas outlet. In the vertical direction, the gas inlet is arranged at a smaller distance from the lower end than the lower gas outlet. The upper gas outlet is arranged at a smaller vertical distance from the upper end than the lower gas outlet. The vertical distance between the upper gas outlet and the lower gas outlet is greater than the vertical distance between the lower gas outlet and the gas inlet.

### CROSS-REFERENCE TO RELATED APPLICATIONS

This application claims priority to the German application number 10 2020 208 690.7 filed on Jul. 10, 2020, the entire contents of which are fully incorporated herein with these references.

### BACKGROUND OF THE INVENTION

The invention relates to a gas generation plant for generating hydrogen-containing synthesis gas from raw material rich in hydrocarbons with a gas generation reactor with a greater height than width, wherein the gas generation reactor comprises:
a. a gas inlet for receiving superheated water vapor;
b. an upper gas outlet for discharging a gas/water vapor mixture;
c. a lower gas outlet for discharging synthesis gas.

The invention also relates to a method for generating synthesis gas using the device according to the invention. Such a device is also known as a down-draft gasifier.

Gas generating reactors for generating hydrogen-containing synthesis gas from raw material rich in hydrocarbons are known from the prior art.

U.S. Pat. No. 7,229,48362 discloses a gas generation reactor into which carbonaceous input material is introduced in the form of small particles. A mixture of oxygen and water vapor is introduced into the gas generation reactor and burned there with ashless fuel such as natural gases to produce ultra-superheated steam that comprises water vapor, carbon dioxide and free radicals at temperatures between 1300° C. and 2760° C. The ultra-superheated steam is combined with the input material in the gas generation reactor under high turbulences, wherein the input material reacts with the ultra-superheated steam to form synthesis gas, which comprises molecular hydrogen, carbon dioxide and carbon monoxide.

A pyrolysis process in a pyrolysis zone is known from EP 2 082 013 B1, wherein the pyrolysis breaks down input material with organic substances into a solid, carbonaceous residue and pyrolysis gas. The pyrolysis gas is reheated with water vapor in a reaction zone with a hydrogen-rich product gas being formed. Circulating bulk material is heated as a heat carrier with heating gases from the combustion of the carbonaceous residue and brought into contact with the mixture of pyrolysis gas and water vapor. The bulk material gives off part of its stored heat to the pyrolysis zone in order to partially or completely provide the heat required for the pyrolysis.

The known processes consume a comparatively high amount of energy and material.

### SUMMARY OF THE INVENTION

### Object of the Invention

It is the object of the present invention to provide a gas generation plant with which the gas generation method can be carried out with less material and with a reduced energy consumption. Another object of the invention is to provide a method that is carried out with the gas generation plant according to the invention.

### Description of the Invention

According to the invention, this object is achieved by using a gas generation plant according to claim 1. The features of the method for generating synthesis gas with the gas generation plant are specified in claim 13. Advantageous embodiments result from the dependent subclaims.

The gas generation plant according to the invention is characterized in that along the longitudinal axis of the gas generation reactor:

an inlet lock for receiving raw material in solid form is provided at an upper end of the gas generation reactor with the gas generation reactor being gas-sealed;

an outlet lock for discharging residual material in solid form is provided at a lower end of the gas generation reactor opposite the upper end, with the gas generation reactor being gas-sealed,

wherein the gas inlet is arranged closer to the lower end than the lower gas outlet and the upper gas outlet is arranged closer to the upper end than the lower gas outlet and the distance between the upper gas outlet and the lower gas outlet is greater than the distance between the lower gas outlet and the gas inlet.

Superheated water vapor is introduced through the gas inlet at the lower end of the gas generation reactor and rises to the upper end. In the context of the invention, superheated water vapor is understood to mean, in particular, water vapor at a temperature above the boiling point in the gas generation reactor. In particular, the water vapor does not contain any droplets. The water vapor, and in particular the gas generation reactor, has a temperature gradient with a higher temperature at the lower end of the gas generation reactor and a lower temperature at the upper end of the gas generation reactor. The hydrocarbon-rich raw material is introduced into the gas generation reactor through the inlet lock at the upper end of the gas generation reactor. The raw material is then conveyed towards the lower end, in particular by gravity. The raw material passes through a drying zone with a temperature at which the raw material is dried, a carbonization zone with a temperature at which the raw material is, in particular as part of an elimination of water, converted into a carbonaceous carbonation product, in particular coal, and a conversion zone with a temperature at which the carbonaceous carbonation product is at least partially converted by the water vapor into a synthesis gas. Residues from the generation of the synthesis gas, in particular with substances not containing carbon dioxide, are discharged from the gas generation reactor as ash from an outlet lock at the lower end of the gas generation reactor. The conversion zone is preferably located between the lower gas outlet and the gas inlet. In particular, the synthesis gas is directed downward with respect to the vertical orientation or the orientation of the gas generation reactor. Among other things, this facilitates the discharge of the synthesis gas into a gas tank. The synthesis gas comprises, in particular, molecular hydrogen, carbon monoxide, carbon dioxide, water molecules and/or methane.

By using a plurality of zones with increasing temperature, synthesis gas can advantageously be generated at a lower temperature of the water vapor. It is not necessary to use bulk material as a heat carrier that is moved in a circuit. The synthesis gas is removed through the lower gas outlet, which is located in the region of the conversion zone. As a result, compared to the prior art, the purity of the synthesis gas that is removed is increased, in particular the dust and tar content of the synthesis gas that is removed is reduced, which reduces the effort required to clean the synthesis gas. The synthesis gas is taken from the reactor in the region of the highest temperature for gas generation purposes, which makes it particularly suitable to be reused for heating purposes. The lower gas outlet preferably delimits the conversion zone at the top in the axial direction so that the synthesis gas rises from the conversion zone in the direction of the gas outlet. The temperature of the mixture of water vapor and other gases, in particular hydrocarbons, contained in the gas generation reactor is, in the drying zone, in particular, up to 150° C. in the carbonation zone, in particular up to 450° C., and in the conversion zone, in particular, up to 900° C., preferably up to 1300° C. The temperature in the conversion zone can be more than 1300° C.

The inlet lock and the outlet lock comprise, in particular, lock gates for sealing the locks and screw conveyors for transporting the raw material or the ash. The terms “up” and “down” refer to the vertical direction, especially the direction of gravity. The length of the gas generation reactor is greater than its width, wherein the gas generation reactor is configured, in particular, with a vertical orientation. It preferably has the shape of a cylinder. The gas generation reactor is preferably formed with a cylindrical chamber. The inlet lock and the outlet lock are preferably formed on the chamber.

The drying takes place, in particular, through the evaporation or vaporization of the raw material. In particular, water vapor, rising fractions of the synthesis gas and volatile carbons form a gas/water vapor mixture in the gas generation reactor. The carbonization or production of carbonaceous material takes place, in particular, at normal pressure under the influence of the heated water vapor by splitting off water molecules from a remaining carbonaceous carbonation product, in particular coal, for example, lignite. Synthesis gas is generated, in particular, by a reaction of the carbon or coal with water molecules in the superheated water vapor, as a result of which molecular hydrogen, carbon monoxide and/or carbon dioxide are generated as components of the synthesis gas.

The gas generation plant is used, in particular, for the gasification of hydrocarbonaceous products and materials such as coal, oil sludge, biomass, municipal waste, plastics, used tires, used oils and mixtures of the substances referenced, which contribute to the production of hydrogen-rich synthesis gas through thermal transformation. The gas generation plant can thus also be used for the industrial production of hydrogen. A large proportion of the carbon is found in the residual material that is removed from the gas generation reactor through the outlet lock. The residual material, also referred to as residual products, includes flue gases that arise, in particular in heating elements, during the combustion of fuel within the scope of the method according to the invention. These only have a comparatively small volume of carbon dioxide since the combustion only serves to heat the outer skin during start-up and to maintain the required temperature of the gas generation reactor.

In particular, this invention relates to a gas generation method and a gas generation plant in which waste containing hydrocarbons is utilized by means of superheated water vapor. The residues or residual substances or residual material arising after the thermal utilization in the gas generation methods can be reused, in particular, for road construction purposes. The superheated water vapor is preferably used as a catalyst for the elimination of harmful exhaust gases and as a cleaning agent against impurities in the gas generation plant or gasification plant. The gas generation plant is self-cleaning to a high degree. In particular, the gas generation reactor can be loaded and unloaded continuously. The temperature of the water vapor when entering into the gas generation reactor ranges, in particular, from 900° C. to 1300° C., preferably 1000° C. As a result, a high calorific value of the synthesis gas and a high degree of efficiency are achieved; in particular, the synthesis gas comprises comparatively high thermal energy. The gas generation plant can have one or more heat exchangers, among other things, to transfer heat from the synthesis gas to the water vapor. The heat exchangers are preferably made of porous ceramic or sheet metal.

The upper gas outlet, in particular for the exit of the gas/water vapor mixture, which comprises, in particular, water vapor and/or flue gases and/or synthesis gas and/or volatile carbons from the drying zone, is preferably formed in a loading zone above the drying zone.

One advantageous embodiment of the gas generation system is characterized in that a synthesis gas collector for receiving the synthesis gas is arranged in the gas generation reactor, which is fluidically connected to the lower gas outlet for releasing the synthesis gas. The synthesis gas collector is preferably arranged at the level of the lower gas outlet, in particular in or on the conversion zone, preferably above the gas inlet in which the synthesis gas is generated. In that case, the synthesis gas collector can receive the synthesis gas immediately after generation and in pure, heated form and transfer it to other heating elements and synthesis gas consumers.

The synthesis gas collector is advantageously tubular and/or arranged on the inner wall of the gas generation reactor in a completely circumferential and/or annular manner. The synthesis gas collector comprises, in particular, an escape pipe for discharging synthesis gas from the gas generation reactor. The synthesis gas is evenly received by the synthesis gas collector through an annular synthesis gas collector that circulates on the inner wall of the gas generation reactor. In particular, the synthesis gas collector comprises a pipe with through openings formed therein. The synthesis gas collector can also have inwardly pointing pipe sections, in particular on the escape pipe, in order to receive synthesis gas generated in the region of the longitudinal axis.

One preferred embodiment is characterized in that a steam gas collector for discharging the gas/water vapor mixture, in particular the water vapor, into the gas generation reactor is arranged in the gas generation reactor and is fluidically connected to the gas inlet. The steam gas collector is preferably arranged at the level of the gas inlet below the lower gas outlet in the conversion zone so that the synthesis gas is generated below the lower gas outlet and then rises in the direction of the lower gas outlet.

The steam gas collector preferably has a tubular design and/or is completely circumferentially arranged on the inner wall of the gas generation reactor and/or is of an annular design. The steam gas collector is arranged, in particular, at the lower end of the gas generation reactor, also referred to as the gas steam reactor. The steam gas collector preferably comprises a pipe with through openings formed therein. The steam gas collector comprises, in particular, an injection pipe, which is traversed by the superheated steam. The shape of the steam gas collector causes the steam to be released evenly around the circumference of the steam gas collector to generate the synthesis gas.

One advantageous development is characterized in that the steam gas collector comprises nozzles, in particular with a plurality of openings. The nozzles are, in particular, arranged along the steam gas collector, preferably in a radially symmetrical manner. The nozzles are designed, for example, as funnels with a taper directed towards the longitudinal axis of the gas generation reactor. Gas, in particular comprising the water vapor, is released through the nozzles in an accelerated manner into the gas generation reactor so that it flows in the direction of the longitudinal axis of the gas generation reactor with increased momentum. This results in a more even distribution of the water vapor. The openings can be formed along the nozzles and/or at the tips of the nozzles in order to further improve the uniformity of the distribution.

Preferred embodiments of the gas generation plant are characterized by a first heating element, wherein the first heating element is arranged, in particular, at the lower end of the gas generation reactor. The first heating element is designed, in particular, as a gas burner. The first heating element is used, in particular, for heating of the outer skin of the gas generation reactor. The gas generation reactor is heated, in particular at its lower end, by the first heating element in order to provide the necessary temperature for carrying out the gas generation process inside the gas generation reactor.

The gas generation plant advantageously comprises a gas distributor for receiving the synthesis gas from the gas generation reactor, wherein the gas distributor is designed to deliver at least part of the synthesis gas to the first heating element, and the first heating element is designed to burn the synthesis gas from the gas distributor. The gas distributor comprises, in particular, a gas inlet for receiving the synthesis gas and one or more gas outlets from which the synthesis gas can exit. The gas generation reactor is fluidically connected to the gas distributor and the gas distributor to the first heating element. To reduce the material and energy consumption, the synthesis gas is burned again to provide the temperature between the lower gas outlet and the lower end of the gas generation reactor necessary to generate the synthesis gas. In some embodiments, the gas generation reactor is operated at least partially with synthesis gas as fuel. The gas distributor comprises, in particular, one or more heat exchangers in order to extract heat from the synthesis gas before the synthesis gas is used further.

A further development is characterized in that the gas distributor is designed to deliver water into the synthesis gas received from the gas generation reactor. The gas distributor comprises a means for releasing water into the synthesis gas received from the gas generation reactor. The gas distributor preferably comprises a water container for storing the water.

One preferred embodiment of the gas generation plant is characterized by a second heating element for receiving and heating the gas/water vapor mixture, in particular water vapor, from the gas generation reactor, wherein the second heating element comprises a fluidic connection with the gas inlet for discharging the gas/water vapor mixture, in particular the heated water vapor, and/or a fluidic connection with the upper gas outlet via a gas suction pump. The gas/water vapor mixture, in particular the water vapor, is preheated by the second heating element before it is fed to the gas generation reactor. The gas/water vapor mixture is passed through a fluidic connection from the upper gas outlet from the gas generation reactor to the second heating element. In particular, the second heating element is designed to heat the water vapor to a desired temperature, in particular up to 1300° C., and/or to control the amount of water vapor leaving the second heating element. The second heating element is preferably used to heat water vapor at the start of the gas generation process. During the gas generation process, energy from the synthesis gas and exothermic reactions are preferably used in the production of a carbon-rich carbonation product, such as coal, from the raw material in the carbonation zone in order to bring about a sufficiently high temperature in the conversion zone. This achieves a high degree of autonomy for the gas generation plant. The second heating element can also be used to heat other substances exiting from the gas generation reactor such as hydrocarbons.

A further development of the gas generation plant is characterized in that the second heating element is designed to generate microwaves. In particular, the second heating element is designed to generate electromagnetic waves with frequencies in the range from 1 GHz to 300 GHz. The water vapor can be particularly efficiently heated, in particular superheated, with microwaves.

One advantageous development of the gas generation plant is characterized in that the gas distributor is designed to deliver synthesis gas from the gas generation reactor to a generator for the generation of electricity, wherein the second heating element for heating the gas/water vapor mixture, in particular water vapor, is formed by using the electricity. The generator is advantageously operated by a motor, which in turn is driven by synthesis gas from the gas distributor. The motor is designed, in particular, as a combustion motor for burning the synthesis gas and operating the generator. This reduces the consumption of materials and energy. All or some of the electricity can be supplied to the second heating element by the power generator which is operated by the motor using the synthesis gas. The efficiency of the gas generation process with the gas generation plant can be increased by supplying heat to the second heating element that comes from heat exchangers to which heated water vapor from the synthesis gas is passed.

A gas generation method for generating synthesis gas with a gas generation plant according to one of the embodiments above comprises the following steps:
a. Hydrocarbonaceous raw material is introduced into the gas generation reactor through an inlet lock at the upper end of a gas generation reactor;
b. The gas generation reactor is heated by a first heating element at a lower end of the gas generation reactor, in particular on its outer skin;
c. Superheated water vapor is introduced into the gas generation reactor through a gas inlet at a lower end of the gas generation reactor;
d. The water vapor flows in the direction of an upper end of the gas generation reactor, wherein a temperature gradient occurs at the upper end of the gas generation reaction with a higher temperature at the lower end and a lower temperature at the upper end of the gas generation reactor;
e. The raw material is conveyed towards the lower end of the gas generation reactor;
f. The raw material passes through a drying zone at a temperature at which the raw material is dried;
g. The raw material passes through a carbonization zone at a temperature at which the raw material is, at least partially under elimination of water, converted into a carbonaceous carbonation product;
h. The carbonaceous carbonation product passes through a conversion zone with a temperature at which the carbonaceous carbonation product is at least partially converted by the water vapor into a synthesis gas;
i. The synthesis gas is discharged from the gas generation reactor through a lower gas outlet in the conversion zone;
j. Residual material, in particular ash, from the generation of the synthesis gas is discharged from the gas generation reactor from an outlet lock at the lower end of the gas generation reactor.

Such a process makes it possible to generate synthesis gas with comparatively little energy and material consumption. In addition, synthesis gas is produced in a particularly pure form.

One advantageous embodiment of the gas generation method is characterized in that at least part of the synthesis gas generated in the gas generation reactor is, by means of a gas distributor, introduced into the first heating element for combustion purposes. The reuse of the synthesis gas to provide the temperature necessary for the generation of the synthesis gas contributes to the reduction of the material and energy consumption in the gas generation process.

One preferred embodiment of the gas generation method is characterized in that the gas/water vapor mixture, in particular comprising water vapor, is passed from the gas generation reactor to a second heating element, heated, in particular superheated by the second heating element, and then introduced again into the gas generation reactor through the gas inlet. The water vapor is preheated before it enters the gas generation reactor. In the process, the water vapor from the gas generation reactor is reused. The water vapor is heated by the second heating element, in particular by using synthesis gas from the gas generation reactor. This way, the material and energy consumption are further reduced.

In particular, raw materials containing carbon, preferably hydrocarbon, are processed by the gas generation plant. An essential feature of the gas generation method or gasification method is the endothermic nature of the most important chemical reactions that occur in the process under consideration, especially for the generation of the synthesis gas. In order to obtain acceptable economic properties, it is necessary to reduce the heat loss. In particular, part of the chemical energy of the resulting synthesis gas is used to supply heat to the gas generation process. The energy consumed depends, in particular, on the moisture content, in particular the water content, of the waste material or the raw material. With a moisture content of the waste material of up to approx. 40%, a gas generation process can be carried out in an energetically sensible manner.

In order to stabilize the parameters of the exiting synthesis gas under the conditions for the processing of gas components in the gas generation reactor, which are heterogeneous in composition and size, it is particularly important to ensure the uniformity of the temperature field within the gas generation reactor and the efficient energy supply.

The gas generation method is suitable for the environmentally friendly treatment of various types of waste as well as the possibility of generating hydrogen-rich synthesis gas. The water vapor acts as an inert medium so that no undesired new chemical compounds arise.

The gas generation reactor or gasification reactor is designed, in particular, to be operated with superheated steam at a temperature of 1300° C. or more and with raw materials and ash residues being continuously loaded and unloaded. The method is implemented by adding and releasing gases or gaseous particles, which are distributed over the entire reactor.

The energy consumption of the gas generation reactor is influenced by the correct choice of the geometric shape and size of the structure as well as the setting of the heat source. The following processes are of essential importance for the heat transport within the scope of the gas generation method: heat conduction, convection and heat radiation.

For the recovery or recuperation of heat, in particular, heat exchangers with large active surfaces and the generator for generating the electricity for the second heating source with the synthesis gas are used.

Further advantages of the invention can be found in the descriptions and the drawings. Likewise, the aforementioned features and those which are to be explained below can each be used individually for themselves or in a plurality of combinations of any kind. The embodiments shown and described are not to be understood as an exhaustive enumeration but rather have exemplary character for the description of the invention.

### BRIEF DESCRIPTION OF THE DRAWINGS

FIG. 1 is a schematic view of a gas generation plant;

FIG. 2 is a schematic view of a vertical cross section through a gas generation reactor of the gas generation plant;

FIG. 3 is a schematic view of a horizontal cross section through the gas generation reactor;

FIG. 4 is a schematic view of a method for generating synthesis gas with the gas generation plant.

### DETAILED DESCRIPTION OF THE PREFERRED EMBODIMENTS

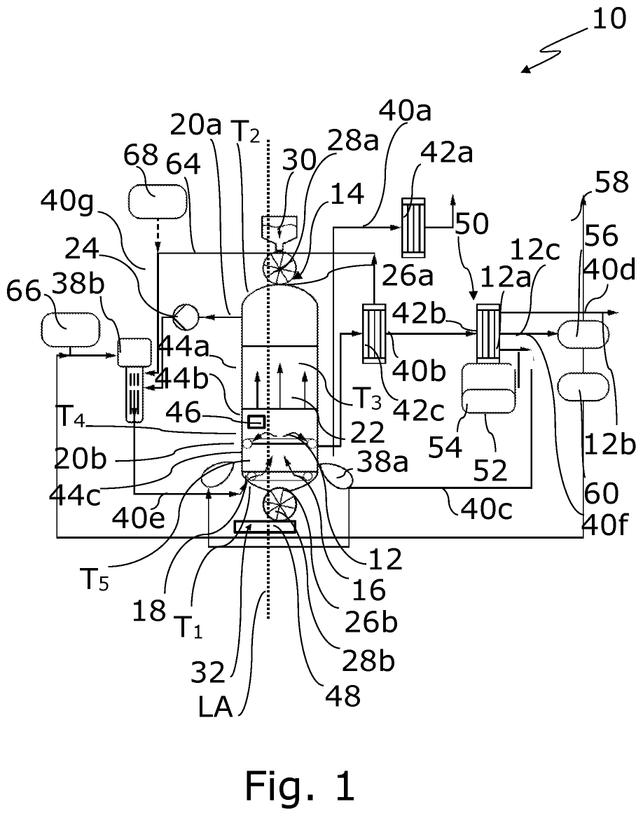

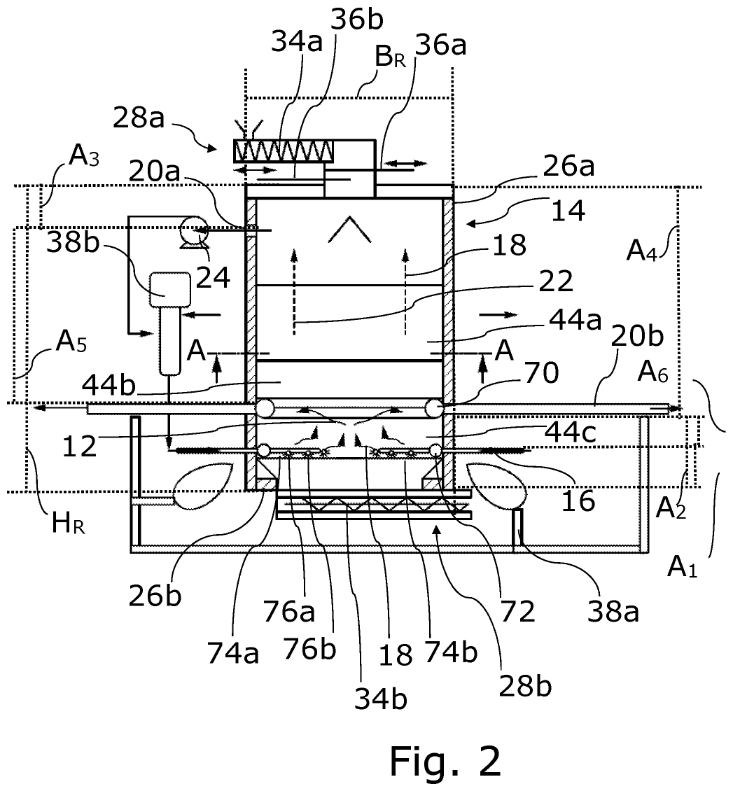

The gas generation plant 10 for generating hydrogen-containing synthesis gas 12 shown in FIG. 1 comprises a gas generation reactor 14. Superheated water vapor 18 and, in particular, gases generated with the gas generation method enter the gas generation reactor 14 through a gas inlet 16 of the gas generation reactor 14. A gas/water vapor mixture 22 is released from the gas generation reactor 14 through an upper gas outlet 20a of the gas generation reactor 14, in particular to a second heating element 38b in the form of a microwave generator (see below). A gas suction pump 24, in particular a suction device with a suction pump, is arranged at the upper gas outlet 20a for suctioning off and further using the gas/water vapor mixture 22 from the gas generation reactor 14. Synthesis gas 12 flows out of the gas generation reactor 14 through a lower gas outlet 20b of the gas generation reactor 14. An inlet lock 28a is formed along a longitudinal axis LA of the gas generation reactor 14 at an upper end 26a of the gas generation reactor 14, through which the raw material 30 containing hydrocarbons can be introduced into the gas generation reactor 14 in solid form. An outlet lock 28b is formed at a lower end 26b of the gas generation reactor 14, through which residual material 32, in particular residues from the synthesis gas generation, preferably in solid form, can be conveyed out of the gas generation reactor 14. The inlet lock 28a and/or the outlet lock 28b comprise a screw conveyor 34a, 34b (see FIG. 2) for transporting the raw material or the residual material 32 as well as lock gates or slides 36a, 36b for sealing the locks 28a, 28b.

A first heating element 38a at the lower end 26b of the gas generation reactor 14 is used to heat the gas generation reactor 14 at its lower end 26b. Flue gas (not shown) from the first heating element 38a flows along the outer skin of the gas generation reactor 14, in particular through a fluidic connection 40a, and through a heat exchanger 42a for setting the temperature of the flue gas before the flue gas is released to the environment. The gas/water vapor mixture 22 flows in the direction of the upper end 26a of the gas generation reactor 14, wherein a temperature gradient occurs with a higher temperature T₁ at the lower end 26b and a lower temperature T₂ at the upper end 26a of the gas generation reactor 14. The raw material 30 is conveyed towards the lower end 26b of the gas generation reactor 14, in particular by gravity.

The raw material 30 passes through a drying zone 44a with a temperature T₃ at which the raw material 30 is dried. The raw material 30 then passes through a carbonization zone 44b with a temperature T₄ at which the raw material 30 is, at least partially under elimination of water, converted into a carbonaceous carbonation product 46, in particular coal. Thereafter, the carbonaceous carbonation product 46 passes through a conversion zone 44c with a temperature T₅ at which the carbonaceous carbonation product 46 is at least partially converted with the water vapor 18 into the synthesis gas 12. The synthesis gas 12 is discharged from the gas generation reactor 14 through the lower gas outlet 20b in the conversion zone 44c. Residual material 32, in particular residues from the generation of the synthesis gas 12, are discharged from the gas generation reactor 14 as ash 48 from the outlet lock 28b at the lower end 26b of the gas generation reactor 14.

A gas distributor 50 receives the synthesis gas 12 from the gas generation reactor 14 via a fluidic connection 40b. The gas distributor 50 conveys a first part 12a of the synthesis gas 12 to the first heating element 38a through a fluidic connection 40c. The first heating element 38a is designed to burn the synthesis gas 12. The gas distributor 50 conveys a second part 12b of the synthesis gas 12 through a fluidic connection 40d to the surroundings of the gas generation plant 10, for example into a tank (not shown). The gas distributor 50 comprises a water tank 52 from which water 54 is supplied to the synthesis gas 12.

A second heating element 38b for receiving and heating the gas/water vapor mixture 22, in particular water vapor 18, from the gas generation reactor 14 comprises a fluidic connection 40e with the gas inlet 16 for the delivery of the heated gas/water vapor mixture 22, in particular the heated water vapor 18. The second heating element 38b is designed to generate microwaves which are used to heat, in particular superheat, the gas/water vapor mixture 22, in particular the water vapor 18. The gas distributor 50 is designed to deliver synthesis gas 12 from the gas generation reactor 14 through a fluidic connection 40f to an internal combustion engine 56 which, while generating exhaust gases 58, drives a generator 60 to generate electricity, wherein the second heating element 38b is designed to heat the second gas/water vapor mixture 22, in particular water vapor 18, by using the electricity. The gas distributor 50 comprises a heat exchanger 42b to be able to set a desired temperature for the synthesis gas. A heat exchanger 42c, which is arranged at the fluidic connection 40b between the lower gas outlet 20b and the gas distributor 50, transfers heat through a pipe 64 to the second heating element 38b to generate the water vapor 18. An electric generator 66 is used to start the second heating element 38b at the beginning of the gas generation process. At the beginning of the gas generation process, water vapor 18 is generated by a steam generator 68 and introduced into the second heating element 38b through a fluidic connection 40g.

FIG. 2 shows a cross section through the gas generation reactor 14 with a synthesis gas collector 70 for receiving the synthesis gas 12 and then releasing the synthesis gas 12 from the gas generation reactor 14. The synthesis gas collector 70 is fluidically connected to the lower gas outlet 20b. A steam gas collector 72 is used to discharge the water vapor 18 into the gas generation reactor 14. Nozzles 74a, 74b of the steam gas collector 72 directed into the interior of the gas generation reactor 14 comprise a plurality of openings 76a, 76b for a uniform distribution of the water vapor 18. Also shown is the gas/water vapor mixture 22, in particular comprising water vapor 18, that rises from the drying zone 44a, the carbonation zone 44b and the conversion zone 44c to the upper gas outlet 20a and is transferred through the gas suction pump 24 to the second heating element 38b, in particular in the form of the microwave generator. The gas/water vapor mixture 22, in particular superheated water vapor 18, is reintroduced into the gas generation reactor 14 through the gas inlet 16. Also shown are the first heating element 38a for heating the gas generation reactor 14 and the second heating element 38b for heating the gas/water vapor mixture 22, in particular the water vapor 18, that is introduced into the gas generation reactor 14 through the gas inlet 16.

The gas generation reactor 14 has a greater height H_{R} than width B_{R.} The vertical distance A₁ between the gas inlet 16 and the lower end 26b of the gas generation reactor 14 is smaller than the distance A₂ between the lower end 26b and the lower gas outlet 20b. The distance A₃ between the upper gas outlet 20a and the upper end 26a of the gas generation reactor 14 is smaller than the distance A₄ between the lower gas outlet 20b and the upper end 26a. The distance A₅ between the upper gas outlet 20a and the lower gas outlet 20b is greater than the distance A₆ between the lower gas outlet 20b and the gas inlet 16.

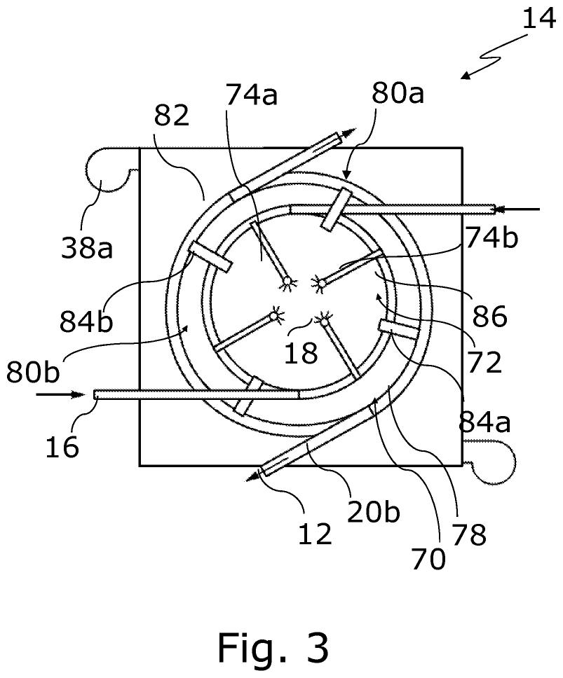

FIG. 3 shows a cross section through the gas generation reactor 14 through the sectional plane designated by AA in FIG. 2. The synthesis gas collector 70 comprises a pipe 78, in particular an escape pipe, for receiving synthesis gas 12. The escape pipe 78 runs completely circumferentially on the inner wall 82 of the gas generation reactor 14 in the form of a ring 80a. The escape pipe 78 leads to the lower gas outlet 20b. Inwardly pointing pipe sections 84a, 84b for receiving the synthesis gas 12 are formed on the escape pipe 78. The first heating element 38a on the gas generation reactor 14 is shown as well.

The steam gas collector 72 comprises an injection tube 86 through which water vapor 18 flows. The injection pipe 86 with the nozzles 74a, 74b arranged on the injection pipe 86 runs in the form of a ring 80b at the lower end 26b (see FIG. 1) of the gas generation reactor 14. The gas inlet 16 opens into the injection pipe 86.

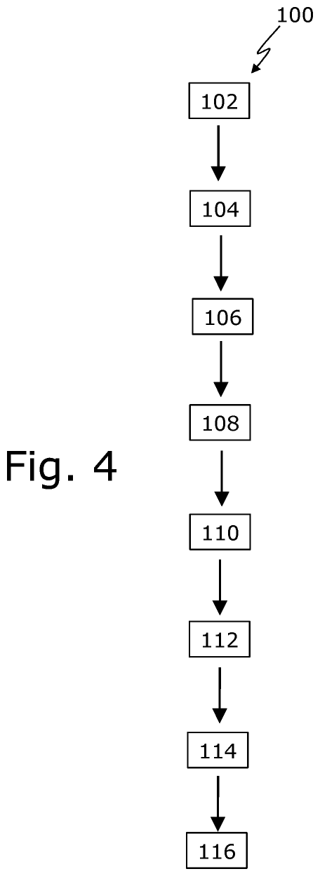

FIG. 4 schematically shows the method 100 for generating synthesis gas 12 with the gas generation plant 10. In a first step 102, in particular after starting the gas generation plant 10, raw material 30 containing hydrocarbons is introduced into the gas generation reactor 14 through an inlet lock 28a at an upper end 26a of a gas generation reactor 14. The raw material 30 is conveyed towards a lower end 26b of the gas generation reactor 14, in particular by gravity. In a second step 104, the gas generation reactor 14 is heated at its lower end 26b by a first heating element 38a at the lower end 26b of the gas generation reactor 14. In a third step 106, superheated water vapor 18 is introduced into the gas generation reactor 14 through a gas inlet 16 at the lower end 26b of the gas generation reactor 14. The water vapor 18 flows in the direction of the upper end 26a of the gas generation reactor 14, wherein a temperature gradient occurs with a higher temperature T₁ at the lower end 26b and a lower temperature T₂ at the upper end 26a of the gas generation reactor 14. In a fourth step 108, the raw material 30 passes through a drying zone 44a with a temperature T₃ at which the raw material 30 is dried. In a fifth step 110, the raw material 30 passes through a carbonization zone 44b with a temperature T₄ at which the raw material 30 is, at least partially under elimination of water, converted into a carbonaceous carbonation product 46. In a sixth step 112, the carbonaceous carbonation product 46 passes through a conversion zone 44c with a temperature T₅ at which the carbon in the carbonaceous carbonation product 46 is at least partially converted with the water vapor 18 into a synthesis gas 12. In a seventh step 114, the synthesis gas 12 is discharged from the gas generation reactor 14 through a lower gas outlet 20b in the conversion zone 44c. In an eighth step 116, residual material 32 from the generation of the synthesis gas 12 is discharged from the gas generation reactor 14 as ash 48 from an outlet lock 28b at the lower end 26b of the gas generation reactor 14.

Taking all the figures of the drawing together, the invention relates to a gas generation plant 10 for generating hydrogen-containing synthesis gas 12. The gas generation plant 10 comprises a gas generation reactor 14. The gas generation reactor 14 is oriented in the vertical direction and has a greater length H_{R} in the vertical direction than the width B_{R}. A gas inlet 16 of the gas generation reactor 14 is designed for a gas/water vapor mixture 22, in particular superheated water vapor 18, to pass through the gas inlet 16 into the gas generation reactor 14. Through an upper gas outlet 20a of the gas generation reactor 14, the gas/water vapor mixture 22 can be conveyed from the gas generation reactor 14 through the upper gas outlet 20a. The gas/water vapor mixture 22 can be reused after having been overheated in the second heating element 38b. Synthesis gas 12 can exit the gas generation reactor 14 through a lower gas outlet 20b. In the vertical direction, the gas inlet 16 is arranged at a smaller distance A₁ from the lower end 26b than the lower gas outlet 20b. The upper gas outlet 20a is arranged at a smaller vertical distance A₃ from the upper end 26a of the gas generation reactor 14 than the lower gas outlet 20b. The vertical distance A₅ between the upper gas outlet 20a and the lower gas outlet 20b is greater than the vertical distance A₆ between the lower gas outlet 20b and the gas inlet 16.

What is claimed is:

1. A gas generation plant for generating hydrogen-containing synthesis gas with a gas generation reactor having a greater height than width, where the gas generation reactor comprises:
a gas inlet for receiving superheated water vapor;
an upper gas outlet for discharging a gas/water vapor mixture;
a lower gas outlet for discharging synthesis gas;
wherein, along a longitudinal axis of the gas generation reactor, an inlet lock for receiving raw material in solid form is provided at an upper end of the gas generation reactor with the gas generation reactor being gas-sealed; and
an outlet lock for discharging residual material in solid form is present at a lower end of the gas generation reactor opposite the upper end with the gas generation reactor being gas-sealed;
wherein the gas inlet is arranged closer to the lower end than the lower gas outlet and wherein the upper gas outlet is arranged closer to the upper end than the lower gas outlet and the distance between the upper gas outlet and the lower gas outlet is greater than the distance between the lower gas outlet and the gas inlet.

2. The gas generation plant according to claim 1, wherein a synthesis gas collector for receiving the synthesis gas is arranged in the gas generation reactor, which is fluidically connected to the lower gas outlet.

3. The gas generation plant according to claim 2, wherein the synthesis gas collector is tubular and/or is arranged on the inner wall of the gas generation reactor in a completely circumferential and/or annular manner.

4. The gas generation plant according to claim 1, wherein a steam gas collector for discharging the gas/water vapor mixture into the gas generation reactor is arranged in the gas generation reactor, which is fluidically connected to the gas inlet.

5. The gas generation plant according to claim 4, wherein the steam gas collector is tubular and/or is arranged on the inner wall of the gas generation reactor in a completely circumferential and/or annular manner.

6. The gas generation plant according to claim 5, wherein the steam gas collector comprises nozzles with a plurality of openings.

7. The gas generation plant according to claim 1, including a first heating element, wherein the first heating element is arranged at the lower end of the gas generation reactor.

8. The gas generation plant according to claim 7, including a gas distributor for receiving the synthesis gas from the gas generation reactor, wherein the gas distributor is designed to deliver at least part of the synthesis gas to the first heating element and the first heating element is designed to burn the synthesis gas from the gas distributor.

9. The gas generation plant according to claim 8, wherein the gas distributor is designed to deliver water into the synthesis gas taken from the gas generation reactor.

10. The gas generation plant according to claim 9, including a second heating element for receiving and heating the gas/water vapor mixture from the gas generation reactor, wherein the second heating element comprises a fluidic connection to the gas inlet for the delivery of the gas/water vapor mixture and/or a fluidic connection to the upper gas outlet via a gas suction pump.

11. The gas generation system according to claim 10, wherein the second heating element is designed to generate microwaves.

12. The gas generation plant according to claim 11, wherein the gas distributor is designed to deliver synthesis gas from the gas generation reactor to a generator for generating electricity, wherein the second heating element is designed to heat the gas/water vapor mixture by using the electricity.

13. A gas generation method for generating the synthesis gas with the gas generation plant according to claim 7, comprising the following steps:
a. introducing raw material containing hydrocarbons into the gas generation reactor through an inlet lock at the upper end of the gas generation reactor;
b. heating the gas generation reactor by the first heating element at the lower end on an outer skin;
c. introducing superheated water vapor into the gas generation reactor through the gas inlet at the lower end of the gas generation reactor;
d. flowing the water vapor in a direction of the upper end of the gas generation reactor, wherein a temperature gradient occurs with a higher temperature T₁ at the lower end and a lower temperature T₂ at the upper end of the gas generation reactor;
e. conveying the raw material towards the lower end of the gas generation reactor;
f. passing the raw material through a drying zone with a temperature T₃ at which the raw material is dried;
g. passing the raw material through a carbonization zone with a temperature T₄ at which the raw material is, at least partially under elimination of water, converted into a carbonaceous carbonation product;
h. passing the carbonaceous carbonation product through a conversion zone with a temperature T₅ at which the carbonaceous carbonation product is at least partially converted with the water vapor into the synthesis gas;
i. discharging the synthesis gas from the gas generation reactor through the lower gas outlet in the conversion zone;
j. discharging residual material from the generation of the synthesis gas from the gas generation reactor as an ash from the outlet lock at the lower end of the gas generation reactor.

14. The gas generation method according to claim 13, wherein at least part of the synthesis gas generated in the gas generation reactor is, by means of a gas distributor, introduced into the first heating element for combustion purposes.

15. The gas generation method according to claim 14, wherein the gas/water vapor mixture is passed from the gas generation reactor to a second heating element, heated by the second heating element and then reintroduced again into the gas generation reactor through the gas inlet.
